(19) United States
(12) Patent Application Publication
(10) Pub. No.: US 2009/0145849 A1
(43) Pub. Date: Jun. 11, 2009

(54) SOLUTION AND METHOD FOR SCAVENGING SULPHUR COMPOUNDS

(75) Inventors: STEPHEN L. DAVIS, Mill Bay (CA); DALE STOREY, Lacombe (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignee: DIVERSIFIED INDUSTRIES LTD., Sidney (CA)

(21) Appl. No.: 11/428,917

(22) Filed: Jul. 6, 2006

Related U.S. Application Data
(60) Provisional application No. 60/595,530, filed on Jul. 12, 2005.

(51) Int. Cl. C09K 3/00; B01D 53/14; C10G 29/20; B01D 15/20; C02F 1/28; C02F 101/10

(52) U.S. Cl. 210/679; 252/189; 95/235; 95/237; 208/236

(57) ABSTRACT

There is disclosed herein a solution for removing a sulphur compound or carbon dioxide from a fluid and methods for its use, said solution comprising a metal at between about 0.05 to 25 percent by weight, an amine at between about 10 to 80 percent by volume and water. The sulphur compound may be hydrogen sulphide or a mercaptan. In one aspect, the method is practiced at temperatures significantly below zero.

### FIELD OF THE INVENTION

This invention relates to a solution that can be used in removing hydrogen sulphide and mercaptans from gases and liquids.

### BACKGROUND OF THE INVENTION

Hydrogen sulphide is a colorless gas, with an odor of rotten eggs. It is produced by bacterial action during the decay of both plant and animal protein and can be formed wherever elemental sulphur or certain sulphur-containing compounds come into contact with organic materials at high temperatures. In industry, it is usually an unintended byproduct, for example from the production of coke from sulphur-containing coal, from the refining of sulphur-containing crude oils, the production of disulphide, the manufacture of vicos rayon, and in the Kraft process for wood pulp.

Natural gases with high concentrations of hydrogen sulphide are known as “sour gases”. Hydrogen sulphide in sour gas and crude oil streams is separated during the “sweetening” process. The most widely used sweetening processes in the industry are the amine processes, which use a solution of water and a chemical amine to remove carbon dioxide and several sulphur compounds.

Hydrogen sulphide is also a byproduct of wastewater from treatment plants or water from agricultural practices. Additionally, hydrogen sulphide can be responsible for the unpleasant odor from liquids used in janitorial processes, RV holding tanks, portable toilets and the like. If the emission of hydrogen sulphide from these liquids can be controlled, then the unpleasant odors may be eliminated.

Hydrogen sulphide is toxic to humans and other animals, and represents a significant threat to public safety and health. It can cause serous health risks, most notably in the oil and gas, livestock, waste management and janitorial industries. At 200 parts per million, humans can no longer smell the gas, and therefore can no longer detect it by smell. Higher concentrations than this can cause nausea and headaches. At 500 to 1,000 parts per million, it causes unconsciousness, with death following in two to twenty minutes unless the victim is removed from the area of exposure immediately.

There is a need for a simple, economical and effective means of capturing hydrogen sulphide gas that is present in other gases, or in liquids.

### SUMMARY OF THE INVENTION

This invention provides a solution that can be used to remove hydrogen sulphide from gases and liquids, and methods for its use. The solution and methods of this invention can also be used to remove, from gases and liquids, other sulphur compounds, such as mercaptans, including methyl mercaptan and ethyl mercaptan. Additionally, the solution and methods of this invention can be used to remove carbon dioxide from gases and liquids, particularly in cold temperatures.

Accordingly, in one aspect the invention is a solution for removing a sulphur compound or carbon dioxide from a gas or a liquid, said solution comprising:

(a) a metal, at between about 0.05 to 25 percent by weight of the solution;
(b) an amine at between about 10 to 80 percent by volume of the solution; and
(c) water.

In one embodiment, the metal is between about 1 to 5 percent by weight of the solution.

The sulphur compound may be hydrogen sulphide, methyl mercaptan, ethyl mercaptan. In various embodiments of the above aspects, the metal is copper, zinc, iron, magnesium or manganese or mixtures thereof. In other embodiments the metal is copper or zinc. In various embodiments of the above aspects, the amine is a primary amine, or monoethanolamine, diglycolamine, methyldiethanolamine, or a mixture of amines. In one embodiment, the amine is present at between about 25 to 50 percent by volume of the solution.

In another aspect, this invention is a method of removing sulphur compound from a fluid, which method comprises:

(a) preparing a solution according to one aspect of this invention, and
(b) contacting the fluid with the solution.

The sulphur compound may be hydrogen sulphide, methyl mercaptan or ethyl mercaptan. The fluid may be a gas, such as natural gas, or air. Alternatively, the fluid may be a liquid, such as a liquid hydrocarbon, drilling mud or water. In one embodiment, this method is practiced at a temperature of between about 0° C. and −50° C.

In another aspect, this invention is a method of removing a sulphur compound or carbon dioxide from a gas or a liquid, which method comprises:

(a) preparing a solution according to the invention, and
(b) contacting the gas or the liquid with the solution.

The sulphur compound is selected from a group consisting of: hydrogen sulphide, methyl mercaptan and ethyl mercaptan. In one embodiment, the method is performed at a temperature of between about 0° C. and −50° C. In another embodiment, the method is performed at a temperature of between about −10° C. and −50° C. In yet another embodiment the method is performed at a temperature of between about −20° C. and −40° C.

### BRIEF DESCRIPTION OF THE DRAWINGS

FIG. 1A is a drawing of an apparatus used in the method of this invention. FIG. 1B is a drawing of another apparatus used in the method of this invention.

### DETAILED DESCRIPTION OF PREFERRED EMBODIMENTS

There is disclosed herein a solution that can be used to remove hydrogen sulphide and other sulphur compounds from gases and liquids, or in any situation where hydrogen sulphide is generated. Particularly, it maybe used to remove hydrogen sulphide from natural gas or liquid hydrocarbons collected from oil and gas wells. “Sulphur compound” as used herein includes hydrogen sulphide, methyl mercaptan and ethyl mercaptan.

The solution of this invention is a mixture of a metal, an amine and water.

The metal component of the solution comprises between about 0.05 to 25 percent by weight of the solution, and exists as a metal ion in solution. In preferred embodiments, the metal component is copper or zinc, however it may be iron, magnesium or manganese. In yet another embodiment, it may be a mixture of any of the above metals. The iron in the solution may be derived from mixing solid iron sulphate with water or another liquid.

In one embodiment the amount of copper in the solution is between about 1 to 99 percent by volume of an about 5 percent by weight solution of copper. In yet another embodiment, the amount of copper in the solution of this invention is between about 25 to 75 percent by volume of an about 5 percent by weight solution of copper. In yet another embodiment, the amount of copper in the solution of this invention is between about 25 to 50 percent by volume of an about 5 percent by weight solution of copper. The copper solution may be derived from mixing solid copper sulphate pentahydrate with water or another liquid. Solid copper sulphate pentahydrate useable in the methods of this invention may be obtained, for example, from HCI Canada Inc., in the form of a solid that is 25.2 percent copper.

In another embodiment the amount of zinc in the solution of this invention is between about 1 to 99 percent by volume of an about 6 to 9 percent by weight solution of zinc. In yet another embodiment, the amount of zinc in the solution of this invention is between about 25 to 75 percent by volume of an about 6 to 9 percent by weight solution of zinc. In yet another embodiment, the amount of zinc in the solution of this invention is between about 25 to 50 percent by volume of an about 6 to 9 percent by weight solution of zinc. The zinc solution may be derived from mixing solid zinc sulphate monohydrate with water or another liquid. Solid zinc sulphate monohydrate useable in the methods of this invention may be obtained, for example, from Tetra Micronutrients, in the form of a solid that is 35.5 to 38 percent zinc.

The amine component of the solution is added as a substantially pure liquid of the amine, or solution of mixed amines. Amines are a colourless, viscous, flammable liquid with a fishy, ammonia-like odor, and they are miscible in water, acetone and methanol. One embodiment of the solution comprises amines in the range of between about 10 to 80 percent by volume of the solution. In another embodiment the solution comprises amines in the range of between about 25 to 75 percent by volume of the solution. On yet another embodiment the solution comprises amines at between about 25 to 50 percent by volume of the solution.

In one embodiment the amine is monoethanolamine, otherwise known as ethanolamine. In other embodiments of the solution other amines, such as diglycolamine (DGA) and methyldiethanolamine (MDEA) or a mixture amines, may be used. The inventors have shown that if the monoethanolamine component of the solution comprises about 2 percent by volume of the final volume of the solution, the solution is stable, meaning that the metal component remains in solution. However, the solution does not work as well at scavenging hydrogen sulphide as when the monoethanolamine component is present at a higher percentage. If the monoethanolamine component of the solution comprises between about 2 and 10 percent by volume of the final volume of the solution, the inventors have shown that solution becomes unstable, in that the metal component will precipitate out of solution. At above 10 percent by volume of monoethanolamine, the solution is once again stable.

The last component of the solution of this invention is water, which may be used to bring the volume of the solution to its desired final volume, or which may already be provided by other components of the solution. One embodiment comprises water at a final volume percentage of between about 20 to 80 percent of the final volume of the solution. Another embodiment comprises water at 25 to 75 percent of the final volume of the solution.

The inventors have shown that various embodiments of the solution of this invention do not freeze at even as low as −51° C. The solution can, therefore, be used to remove hydrogen sulphide and other sulphur compounds and other contaminants, in very cold environments. It is noted that the removal of carbon dioxide by this solution appears to be more efficient at cold temperatures than at warmer temperatures. The significant depression of the freezing point provides the benefit of being able to use this solution at temperatures which would cause other solutions, and in particular other solutions that can be used to scavenge hydrogen sulphide, to freeze. A particularly beneficial use of this solution is in truck scrubbers, as they are used in the field, and may be used at temperatures significantly below freezing. The fact that this solution does not freeze at very low temperatures provides the additional benefit that storage of the solution is simplified, as the potential for the solution to freeze during storage is not a concern. With a freezing point of below −51° C., it is likely that the solution could be used to remove sulphur compounds and carbon dioxide from gases that are at this temperature.

Having thus disclosed the various components of the solution, an example of how the solution is prepared will now be disclosed. However, this invention is not intended to be limited by the order or method in which the components are mixed together, unless the components cannot be mixed in that order, or by that method, to provide the solution that is disclosed herein. Additionally, this invention is not intended to be limited by the chemicals used in the examples below.

In its broadest aspect, the solution of this invention can be made by mixing together the amine component and water, and then by adding to this mixture, the metal, as either a solid salt or salt in solution. Alternately, the amine component and metal may be mixed together, and the water added thereto. Alternately again, the metal and water may be mixed together, and the amine added thereto.

As an example, the inventors first mix the metal salt and water together. One method of preparing this metal/water mixture is to mix 50 gallons of water with two 50-pound bags of solid copper sulphate pentahydrate obtained, for example, from HCI Canada Inc., in the form of a solid that is 25.2 percent copper. This metal/water mixture will therefore comprise about 5 percent by weight copper. If zinc is the metal component of the solution, solid zinc sulphate monohydrate obtained, for example, from Tetra Micronutrients, in the form of a solid that is 35.5 to 38 percent zinc, may be added with mixing, to a final concentration of about 6 to 9 percent zinc by weight.

Additional water should not be added to the amine component. The metal, whether as a mixture with water, or metal salt alone, is quickly added to the amine component, with mixing to prevent precipitation of the metal. When the metal is zinc, mixing must be particularly vigorous, as zinc will otherwise precipitate out of the solution.

If the amine component will be less than about 37% by volume of the solution, water should not be added to the amine component before the metal is mixed with the amine. Rather, additional water should be added to the metal first, and then this solution is added to the amine component. More vigorous blending is required in this embodiment of the solution, to ensure that the solution is stable.

One embodiment of the solution comprises about 30 percent by volume of a 5 percent (w/w) copper solution, about 16 percent by volume monoethanolamine, about 40 percent by volume ethylene glycol, and water.

In another embodiment, the solution comprises about 30 percent by volume of a 5 percent (w/w) copper solution, about 30 percent by volume monoethanolamine, about 40 percent by volume methanol, and water.

In another embodiment, the solution comprises about 30 percent by volume of a 9 percent (w/w) zinc solution, about 30 percent by volume monoethanolamine, about 40 percent by volume ethylene glycol, and water In another embodiment the solution comprises about 25 percent by volume of a 5 percent (w/w) copper solution, about 16.7 percent by volume monoethanolamine, about 41.6 percent by volume ethylene glycol, and water.

In another embodiment the solution comprises about 50 percent by volume of a 5 percent (w/w) copper solution, about 50 percent by volume monoethanolamine, and water.

In another embodiment the solution comprises about 50 percent by volume of a 6 percent (w/w) zinc solution, about 50 percent by volume monoethanolamine, and water.

In another embodiment the solution comprises about 50 percent by volume of a 9 percent (w/w) zinc solution and about 50 percent by volume monoethanolamine.

In another embodiment the solution comprises about 50 percent by volume of a 5 percent (w/w) copper solution, about 25 percent by volume monoethanolamine, and water.

In another embodiment the solution comprises about 50 percent by volume of a 6 percent (w/w) zinc solution, 25 percent by volume monoethanolamine, and water.

Having thus disclosed the solution of this invention and how it is prepared, the methods for using the solution will now be disclosed. In its broadest terms, one method of this invention is to prepare the solution as described, and then to bring the solution into contact with a fluid that contains hydrogen sulphide. The fluid may be a gas or a liquid. As used herein, “gas” means a form of matter that has no fixed volume and will conform in volume to the space available, and is intended to include mixtures of gases, such as air. For example, the gas can be natural gas that contains hydrogen sulphide, it can be air that contains hydrogen sulphide, and which is emitted from wastewater or from agricultural operations, RV holding tanks, or portable toilets, for example. The solution will, upon contact with the hydrogen sulphide-containing gas or air, remove all or a significant portion of, the hydrogen sulphide. Without being limited to a theory, the hydrogen sulphide reacts with the copper, zinc or iron in the solution to form cupric, zinc or iron sulphide, respectively, which are insoluble molecules that precipitate out of the solution.

Alternatively or in addition to hydrogen sulphide, a gas that is used in the methods of this invention may comprise other sulphur compounds. For example, the gas may comprise mercaptans such as methyl mercaptan and ethyl mercaptan. The solution will, upon contact with a gas comprising one or more of these sulphur compounds, remove all or a significant portion of these other sulphur compounds from the gas.

Alternatively or in addition, a gas that is used in the methods of this invention may comprise carbon dioxide. The solution of this invention will, upon contact with a gas comprising carbon dioxide, remove a significant portion of the carbon dioxide from the gas. This removal appears to be most efficient at cold temperatures. The solution also appears to have some effect on nitrogen levels.

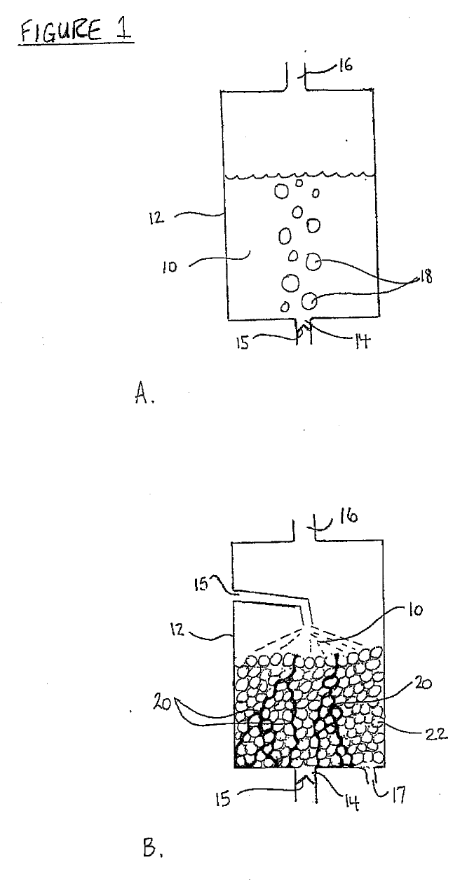

The solution may be used to remove gaseous sulphur compounds and carbon dioxide from gases, a process known as “gas scrubbing.” FIG. 1A shows one embodiment of the method of this invention in which a gas comprising one or more compounds that are to be removed from the gas is bubbled through a solution of the invention. Examples of the compounds that are to be removed from the gas include, hydrogen sulphide, mercaptans, such as methyl mercaptan or ethyl mercaptan, and carbon dioxide. As seen in FIG. 1, solution 10 is placed into a container 12 that has an entrance opening 14 and an exit opening 16. Entrance opening is fitted with a device 15, such as a one-way valve, that will prevent solution 10 from running out of container 12. The gas 18 enters container 12 through entrance opening 14 and passes through solution 10 by rising upwards because of its low density. Gas 18 exits container 12 through exit opening 16.

As is apparent, the gas 18 moves through solution 10 as a series of bubbles, which increases the surface area of the interaction between solution 10 and gas 18, and causes turbulence in solution 10, both of which increase the efficiency of removal of the desired compounds from gas 18.

FIG. 1B shows another embodiment of the method of this invention, in which solution 10 is passed through tortuous paths 20 in container 12, rather than simply being introduced into container 12 as a volume of liquid. In the method of this embodiment, container 12 again comprises entrance opening 14 and exit opening 16 through which a gas 18 will enter into and exit from container 12. These openings are positioned such that gas 18 must pass through the tortuous paths 20 after entering and before exiting container 12. Additionally, container 12 comprises an opening 15 and an exit 17, through which solution 10 will enter and exit container 12, which are positioned such that solution 10 must pass through the tortuous paths 20 after entering and before exiting container 12. As is apparent, the tortuous paths both increase contact of solution 10 with gas 18, and also provide turbulence to solution 10, both of which increase the efficiency of removal of the compounds from gas 18.

FIG. 1B demonstrates an embodiment of this invention in which the tortuous path is created by introducing a plurality of objects 22, such as small circular balls or “raschig rings”, into container 12. In one embodiment, these balls are approximately the size of a golf ball. However, balls of different or varying sizes, objects that are not round, but oval or discoid, objects that have rounded and flat edges, or objects with flat edges may be used. Any objects that would function to cause solution 10 and gas 18 to travel around and between them, are intended to be included herein. These objects function to increase the surface area of interaction between the solution 10 and gas 18.

In this embodiment of the method of this invention, solution 10 is introduced into container 12, in such a way that maximizes its contact with the surface of the objects 22. As demonstrated in FIG. 1B, this may be accomplished by spraying solution 10 over the top surface of the objects, whereafter it will trickle down through the various tortuous paths.

Container 12 may be adapted to collect the gas that exits through exit opening 16, for example to collect natural gas. Alternatively, if the gas 18 is not to be collected, such as after the compounds have been removed from gases emitting from wastewater or from water used in agricultural operations, the gas would be released directly into the atmosphere, presuming it is otherwise clean.

In yet another embodiment of the method of this invention, the solution is mixed with water and misted into a vessel containing gaseous sulphur compounds and carbon dioxide.

In yet another embodiment of this method that is used with steam injection, the solution is injected into steam to react with any sulphur compounds and carbon dioxide that might be in the atmosphere as well as react with any liquids that might be within the tank.

In yet another embodiment of this method, the solution is merely injected into a container comprising a gas and the contact between the solution and the gas removes the gaseous sulphur compounds and carbon dioxide from the gas.

The solution may also be used to remove sulphur compounds and carbon dioxide from liquids. Therefore, another embodiment of the method of this invention is to prepare the solution as described, and then to mix the solution with another liquid that contains one or more of hydrogen sulphide, mercaptans, such as methyl mercaptan and ethyl mercaptan, or carbon dioxide. When the solution and the liquid are mixed, and without being limited to a theory, the sulphur compounds in the liquid will react with the metal in the solution to form a metal sulphide, an insoluble molecule that precipitates out of the solution. This precipitate can be removed from the mixture, for example by filtration or centrifugation. Alternatively, removal of the precipitate may not be necessary, for instance in a situation where the liquid is a drilling fluid used in oil and gas well drilling.

For example, the solution can be used to reduce or eliminate sulphur compounds in liquid hydrocarbons by injecting the solution into the hydrocarbon and ensuring subsequent mixing of the solution with the hydrocarbon. This can be accomplished, for example, by using an injection pump to add the solution to the hydrocarbon contained in a pipeline. A specific example would be injection of the solution into the flowline of an oil producing well, or directly down into the well through the casing. Treatment of a liquid with the solution can also be accomplished by adding the solution to tanks containing the liquid. For example, the solution may be added to the contents of truck tankers or tanker ships. Liquid hydrocarbons that can be treated in this manner include crude oils, natural gas condensates, liquefied petroleum gas and refined products such as fuel oils.

In yet another embodiment, drilling mud is mixed with the solution of this invention, in order to remove therefrom a number of compounds including, hydrogen sulphide, mercaptans such as methyl mercaptan and ethyl mercaptan, or carbon dioxide.

The solution may also be used to reduce or eliminate sulphur compounds in water, known as “sour water”, which contains hydrogen sulphide and mercaptans. The solution may also be used to eliminate odours arising from liquids, since the source of many odours is sulphur compounds, which would be removed by the solution. The solution may therefore be applied to odorous waters, such as at waste treatment plants.

As will be apparent to those skilled in the art, various modifications, adaptations and variations of the preceding and foregoing specific disclosure can be made without departing from the scope of the invention claimed herein. The following examples are intended only to illustrate and describe the invention rather than limit the claims that follow.

### EXAMPLES

Each of tests 1-6 was conducted in a test vessel that had a test tower which was four-inches in diameter and 10 feet tall, and included a sparger bar ¾-inches in diameter and about 4 inches long with eight holes, 3/32 inches in diameter, drilled at a 45 degree angle alternately to each side of center. A flow meter was used to measure gas flow and there was a flow line to the flare stack. The gas used in these tests was sour gas. Pressure, temperature, and the H₂S content of the gas varied between tests.

The concentration of the H₂S in the gas used varied because several different oil and gas wells were fed into the test complex. If the operator had problems and shut in some wells, the amount of H₂S in the sample would change, as H₂S content differed from well to well.

When there was pressure on the tower, actual flow rates were considerably higher because the gas was compressed. There are set differentials for pressure. The earlier of these tests did not record any pressure, because it was cold outside and the line to flare was clear plastic, so any blow by could be observed. In the winter, the plastic hose maintained its round structure, and the flow was not restricted. The summary data reported at the end of this section includes a 3 psi pressure factor that was included because of the height of the fluid in the tower.

The later tests were done at a warmer temperature and the flare line collapsed because it was made of plastic, causing back pressure on the system. A pressure of 5 to 10 psi caused considerable differences in actual flow rates. The summary data reported at the end allows for these pressure differences. Pressure in working vessels will keep gas bubbles smaller, allowing for better contact with liquids it is bubbling through.

The results of tests of various solutions are outlined in the tables below. The object of these tests was to determine how long each solution was able to maintain an “H₂S Out” (see below) of 0 ppm of H₂S. The “breakthrough point” is the point at which “H₂S Out” rises above 0 ppm of H₂S. “Time” is the time of day when the measurements were recorded. “Flow” is the flow rate of natural gas from an on-site well. “H₂S In” is the concentration of hydrogen sulphide in the gas that is entering the tower, and “H₂S Out” is the concentration of hydrogen sulphide in the gas that exits the solution in the tower. “Colour” is the colour of the solution near the middle of the solution when it is in the tower. “Fluid level” is the level that the fluid reaches in the tower while the gas is flowing into the tower. All tests used a volume of 10 litres of solution.

### Test #1

A solution of 100% (v/v) monoethanolamine was tested. The outside temperature was −2° C. The results are shown in Table 1. The solution was very difficult to drain out of the tower after this test was completed—although it was very runny, something held the flow back.

TABLE 1

| | Flow | H₂S In | H₂S Out | | | Fluid Level |
|---|---|---|---|---|---|---|
| Time | (m³) | (ppm) | (ppm) | Colour | pH | (in) |
| 11:55 | 29.97 | 2000 | 0 | dark | 12.5 | 55 |
| | 33.28 | ″ | 5 | dark | | 103 |
| 12:25 | 36.64 | ″ | 20 | dark | | ″ |

### Test #2

A solution of Sulfa Scrub HSW2001 (Baker Petrolite) was tested. The outside temperature was −4° C. The results are shown in Table 2. This solution did not foam and was still very fluid at 3:45. This solution contains 10% formaldehyde. After breakthrough occurs, the solution appears to maintain relatively low emission of H₂S for some time, but these emissions would be unacceptable in applications where 0 ppm must be maintained.

TABLE 2

| | Flow | H₂S In | H₂S Out | | | Fluid Level |
|---|---|---|---|---|---|---|
| Time | (m³) | (ppm) | (ppm) | Colour | pH | (in) |
| 11:50 | 173.21 | 400 | 0 | black | | 42 |
| 12:15 | 179.23 | ″ | ″ | ″ | | 76 |
| 12:30 | 182.77 | ″ | ″ | ″ | | ″ |
| 12:45 | 186.49 | ″ | ″ | ″ | | ″ |
| 1:00 | 190.10 | ″ | ″ | ″ | | ″ |
| 1:15 | 193.53 | ″ | ″ | ″ | | ″ |
| 1:30 | 196.90 | ″ | ″ | ″ | | ″ |
| 1:45 | 200.26 | ″ | ″ | ″ | | ″ |
| 2:00 | 203.52 | ″ | ″ | ″ | | ″ |
| 2:15 | 206.85 | ″ | ″ | ″ | | ″ |
| 2:30 | 209.90 | ″ | ″ | ″ | | 66 |
| 2:45 | 213.08 | ″ | ″ | ″ | | ″ |
| 3:00 | 216.34 | ″ | ″ | ″ | | ″ |
| 3:15 | 219.60 | ″ | ″ | ″ | | 61 |
| 3:30 | 222.77 | ″ | ″ | ″ | | ″ |
| 3:45 | 226.14 | ″ | ″ | ″ | | ″ |
| 4:00 | 229.49 | 400 | 0 | black | | 61 |
| 4:15 | 232.94 | ″ | ″ | ″ | | ″ |
| 4:30 | 236.23 | ″ | ″ | ″ | | ″ |
| 4:45 | 239.64 | ″ | ″ | ″ | | ″ |
| 5:00 | 243.22 | ″ | ″ | ″ | | ″ |
| 5:15 | 247.18 | ″ | ″ | ″ | | ″ |
| 5:30 | 250.70 | ″ | ″ | ″ | | ″ |
| 5:45 | 254.36 | ″ | ″ | ″ | | ″ |
| 6:00 | 258.20 | ″ | ″ | ″ | | ″ |
| 6:15 | 261.46 | ″ | 5 | ″ | | ″ |
| 6:30 | 264.80 | ″ | 10 | ″ | | 60 |
| 6:45 | 267.86 | ″ | 10 | ″ | | ″ |
| 7:00 | 271.05 | ″ | 15 | ″ | | ″ |
| 7:15 | 274.35 | ″ | 20 | ″ | | ″ |
| 7:30 | 277.42 | ″ | 15 | ″ | | ″ |
| 7:45 | 280.79 | 200 | 25 | ″ | 8.2 | ″ |

### Test #3

A solution of 30% (w/w) of ammonium hydroxide (Strike Oilfield Services, or, Univar) was tested using the above methods. The outside temperature was −7° C. The results are shown in Table 3. By 7:15 the solution was very dark.

TABLE 3

| | Flow | H₂S In | H₂S Out | | | Fluid Level |
|---|---|---|---|---|---|---|
| Time | (m³) | (ppm) | (ppm) | Colour | pH | (in) |
| 5:50 | 405.23 | 200 | 0 | milky, clear | 14.4 | 44 |
| 5:53 | 405.70 | ″ | ″ | grey, dark | ″ | 85 |
| 6:00 | 407.96 | ″ | ″ | dark | ″ | 97 |
| 6:15 | 410.98 | 500 | ″ | ″ | ″ | 79 |
| 6:30 | 414.47 | ″ | ″ | ″ | ″ | ″ |
| 6:45 | 418.00 | ″ | ″ | ″ | ″ | ″ |
| 7:00 | 421.64 | ″ | 10 | ″ | ″ | ″ |
| 7:15 | 425.48 | ″ | 35 | ″ | ″ | ″ |
| 7:30 | 428.72 | ″ | 250 | ″ | 9.8 | 38 |

### Test #4

A solution of HSW705F (Baker Petrolite) was tested. The outside temperature was −12° C. and 28 psi of pressure was applied to the solution. The results are shown in Table 4. No foaming occurred. At the end of the test there was 200 ppm H₂S In. Gas volume dropped off dramatically.

TABLE 4

| | Flow | H₂S In | H₂S Out | | | Fluid Level |
|---|---|---|---|---|---|---|
| Time | (m³) | (ppm) | (ppm) | Colour | pH | (in) |
| 9:55 | 290.00 | 400 | 0 | clear | 10.4 | 42 |
| 10:15 | 294.44 | ″ | ″ | ″ | ″ | 72 |
| 10:30 | 297.84 | ″ | 10 | fairly clear | ″ | ″ |
| 10:45 | 300.23 | ″ | 15 | ″ | ″ | 62 |
| 11:00 | 302.15 | ″ | ″ | ″ | ″ | ″ |
| 11:15 | 303.70 | ″ | 10 | ″ | ″ | ″ |

### Test #5

A solution of 3.5% (w/w) zinc and 25% (v/v) monoethanolamine was tested. The outside temperature was 26° C. and 5 psi of pressure was applied to the solution. The results are shown in Table 5. The solution was fairly thick to begin with. At 3:00 the flow was cut, because the pressure was too high, after which the pressure was held at 5 psi.

TABLE 5

| | Flow | H₂S In | H₂S Out | | Pressure | Fluid Level |
|---|---|---|---|---|---|---|
| Time | (m³) | (ppm) | (ppm) | Colour | (psi) | (in) |
| 2:15 | 617.92 | 2000+ | 0 | brown | 5 | 46 |
| 3:00 | 627.20 | ″ | ″ | ″ | 10 | 102 |
| 3:15 | 629.96 | ″ | ″ | ″ | 5 | ″ |
| 3:45 | 635.90 | ″ | ″ | ″ | 5 | 97 |
| 4:15 | 641.02 | ″ | ″ | ″ | 5 | 92 |
| 4:45 | 647.21 | ″ | ″ | ″ | 5 | ″ |
| 5:15 | 653.28 | ″ | ″ | ″ | 5 | 97 |
| 5:45 | 659.00 | ″ | ″ | ″ | 5 | ″ |
| 6:15 | 664.57 | ″ | ″ | ″ | 5 | 92 |
| 6:45 | 669.97 | ″ | 10 | ″ | 5 | |

### Test #6

A solution of 3.6% (w/w) zinc and 20% (v/v) monoethanolamine was tested. The outside temperature was 24° C. and 5 psi of pressure existed within the tower or column. The results are shown in Table 6. In this solution the zinc did not seem to be completely dissolved. Sticking of byproduct to the sides of the vessel was observed beginning at 12:40. The fluid was thin and drained well from the tower after the test was over.

TABLE 6

| | | | | | Pres- | Fluid |
|---|---|---|---|---|---|---|
| | Flow | H₂S In | H₂S Out | | sure | Level |
| Time | (m³) | (ppm) | (ppm) | Colour | (psi) | (in) |
| 11:20 | 670.00 | 2000 | 0 | white | 5 | 46 |
| 12:40 | 683.75 | ″ | ″ | yellow brown | 5 | 92 |
| 1:20 | 691.90 | ″ | ″ | ″ | 5 | ″ |
| 2:20 | 704.58 | ″ | ″ | ″ | 5 | ″ |
| 2:50 | 710.43 | ″ | ″ | ″ | 5 | ″ |
| 3:20 | 716.77 | ″ | ″ | ″ | 5 | ″ |
| 3:50 | 721.53 | ″ | ″ | ″ | 5 | ″ |
| 4:25 | 727.75 | ″ | 15 | red grey | 5 | ″ |

### SUMMARY

The amount of hydrogen sulphide removed in each of the above tests is as follows

| | | Hydrogen Sulphide removed |
|---|---|---|
| | Solution Composition | (Grams H₂S/Litre of solution) |
| Test #1 | 100% MEA | 2.2 |
| Test #2 | Baker HSW2001 | 7.2 |
| Test #3 | 30% Ammonium Hydroxide | 1.6 |
| Test #4 | Baker HSW705F | 2.0 |
| Test #5 | 3.5% Zn/25% MEA | 19.4 |
| Test #6 | 3.6% Zn/20% MEA | 21.7 |

As is apparent, the solution of metal and amine removes significantly more hydrogen sulphide from the gas than any of the other solutions tested.

### Examples

### Treatment of Liquids

A solution was prepared containing:
(a) 11.34 gm Zinc Sulphate Monohydrate.
(b) 52.0 ml Monoethanolamine (MEA)
(c) 47.3 ml water.

The solution composition is: 3.6% (w/w) zinc and 52% (v/v) MEA.

A sour oil sample was obtained and the hydrogen sulphide in the gas space above the sample was measured at 3% by volume, using a modified ASTM #5705 procedure.

10.6 ml of the prepared solution was added to 500 ml of a sour oil sample in a closed flask and shaken for 3 min. The amount of hydrogen sulphide in the gas space above the sample was analyzed at 18 ppm (v). At 60 minutes after the addition of the prepared solution, the oil sample was again shaken and the gas space was analyzed for hydrogen sulphide. There was no detectable hydrogen sulphide in the gas space.

We claim:

1. A solution for removing a sulphur compound from a fluid, said solution comprising:
(a) a metal, at between about 0.05 to 25 percent by weight of the solution;
(b) an amine, at between about 10 to 80 percent by volume of the solution; and
(c) water.

2. The solution of claim 1 wherein the sulphur compound is selected from a group consisting of: hydrogen sulphide, methyl mercaptan and ethyl mercaptan.

3. The solution of claim 1 wherein the metal is selected from a group consisting of: copper, zinc, iron, magnesium or manganese.

4. The solution of claim 1 wherein the metal is copper.

5. The solution of claim 1 wherein the metal is zinc.

6. The solution of claim 1 wherein the amine is a primary amine.

7. The solution of claim 1 wherein the amine is selected from a group consisting of: monoethanolamine, diglycolamine, methyldiethanolamine.

8. The solution of claim 1 wherein the amine is a mixture of amines.

9. The solution of claim 3 wherein the metal is present at between about 1 to 5 percent by weight of the solution.

10. The solution of claim 9 wherein the amine is present at between about 25 to 50 percent by volume of the solution.

11. A method of removing a sulphur compound from a fluid, comprising:
(a) preparing a solution according to any one of the above claims, and
(b) contacting the fluid with the solution.

12. The method of claim 11 wherein the sulphur compound is selected from a group consisting of: hydrogen sulphide, methyl mercaptan and ethyl mercaptan.

13. The method of claim 11 wherein the fluid is a gas.

14. The method of claim 11 wherein the fluid is a liquid.

15. The method of claim 13 wherein the gas is natural gas.

16. The method of claim 13 wherein the gas is air.

17. The method of claim 14 wherein the liquid comprises a liquid hydrocarbon.

18. The method of claim 14 wherein the liquid is drilling mud.

19. The method of claim 14 wherein the liquid is water.

20. The method of claim 11 practiced at a temperature of between about 0° C. and −50° C.

21. A method of removing a sulphur compound or carbon dioxide from a gas or a liquid, which method comprises:
(a) preparing a solution according to any one of the above claims, and
(b) contacting the gas or the liquid with the solution.

22. The method of claim 21 wherein the sulphur compound is selected from a group consisting of: hydrogen sulphide, methyl mercaptan and ethyl mercaptan.

23. The method of claim 21 performed at a temperature of between about 0° C. and −50° C.

24. The method of claim 21 performed at a temperature of between about −10° C. and −50° C.

25. The method of claim 21 performed at a temperature of between about −20° C. and −40° C.
